(19) United States
(12) Patent Application Publication
(10) Pub. No.: US 2008/0095043 A1
(43) Pub. Date: Apr. 24, 2008

(54) Computer platform management unit operating mode arbitration method and system

(75) Inventor: Chun-Liang Lee, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/586,230

(22) Filed: Oct. 24, 2006

(51) Int. Cl. G06F 11/00; H04J 3/14

(52) U.S. Cl. 370/217; 370/242; 714/1

(57) ABSTRACT

A computer platform management unit operating mode arbitration method and system is proposed, which is designed for use with a computer platform having multiple management units, such as a blade server, and which is characterized by the utilization of a network interface for message exchanges between the management units, and the utilization of a random timer to set a waiting time length for local management unit to wait for a response from neighboring management unit that tells whether its current operating mode is active mode or standby mode. If no response is received, the local management unit is set to active mode; otherwise, it is set to an operating mode other than the current operating mode of the neighboring management unit. This feature allows the mechanism of operating mode arbitration on the blade server to be more simplified such that the implementation thereof is more cost-effective.

### BACKGROUND OF THE INVENTION

1. Field of the Invention

This invention relates to information technology (IT), and more particularly, to a computer platform management unit operating mode arbitration method and system which is designed for use in conjunction with a computer platform, particularly a clustering type of computer platform of the type having multiple management units, such as a blade server, for providing the computer platform with an operating mode arbitration function.

2. Description of Related Art:

Conventionally, a blade server system can be installed with up to 20 blade-like server modules or more based on customer's on-field demand. Since a blade server system has such a high level of capacity and functionality, it has become a highly-demanded unit in enterprise-level network systems.

In practice, in order to provide management and control to the multiple server modules in a blade server system, one of the server modules is selected as a master management unit which is linked to an external network system and acts as a channel for all the other server modules to communicate with the network. In the event of a failure to the blade server system, the master management unit is also responsible for transmitting related status information and messages to remote client workstations. Moreover, remote client workstations can inquire status information about the operations of the blade server system via the master management unit.

In addition, in order to prevent the entire blade server system to fail to operate normally due to a failure of the master management unit, another server module is selected to act as a slave management unit, such that in the event of a failure to the master management unit, the slave management unit will replace the master management unit and take over the operations thereof so that the entire blade server system can nevertheless maintain normal operations.

Conventionally, in the event of a failover, CPLD (Complex Programmable Logic Device) based hardware circuitry is used for the control of the switching from the master management unit to the slave management unit. Since CPLD is a well-known hardware technology in computer engineering, detailed description thereof will not be given in this specification. One drawback to this practice, however, is that it requires complex hardware circuits to implement, and therefore is quite inflexible. Moreover, since the master management unit and the slave management unit are based on different architectures, the use of CPLD circuitry for the switching is quite complex and thus costly to implement.

### SUMMARY OF THE INVENTION

It is therefore an objective of this invention to provide a computer platform management unit operating mode arbitration method and system which is capable of providing an operating mode arbitration function for arbitration of operating mode between multiple management units more conveniently and quickly.

It is another objective of this invention to provide a computer platform management unit operating mode arbitration method and system which can be implemented without having to install additional hardware for arbitration of operating mode between multiple management units, and which allows easy user-selected switching that has a higher level of flexibility in utilization.

The computer platform management unit operating mode arbitration method and system according to the invention is designed for use in conjunction with a computer platform, particularly a clustering type of computer platform of the type having multiple management units, such as a blade server, for providing the computer platform with an operating mode arbitration function.

The computer platform management unit operating mode arbitration method according to the invention comprises: (P1) in the event of the computer platform being started, commanding the first management unit to detect the current presence status of the second management unit via the network interface; if the presence status is false, setting the first management unit to an active mode; (P2) whereas if the presence status of the second management unit is true, issuing a neighboring unit operating mode inspection requesting message via the network interface to the second management unit for requesting the second management unit to return an operating mode informing message; (P3) if the returned operating mode informing message indicates active mode, issuing a standby mode enable message; (P4) if no message is returned from the second management unit, generating a random time length and then starting countdown until the elapse of the time length, during which the neighboring unit operating mode inspection module keeps inspecting whether an operating mode informing message indicative of active mode is returned from the second management unit; and at the termination of the randomly-generated time length, issuing an active mode enable message; and (P5) responding to each standby mode enable message by setting the first management unit to standby mode, and responding to each active mode enable message by setting the first management unit to active mode.

In modularized architecture, the computer platform management unit operating mode arbitration system according to the invention comprises: (A) a neighboring unit presence status detecting module, which is capable of responding to a starting event on the computer platform by commanding the first management unit to detect the current presence status of the second management unit via the network interface; if the presence status is false, capable of setting the first management unit to an active mode; whereas if the presence status is true, capable of issuing a neighboring unit operating mode inspection enable message; (B) a neighboring unit operating mode inspection module, which is capable of responding to the neighboring unit operating mode inspection enable message from the neighboring unit presence status detecting module by issuing an operating mode inspection request message via the network interface to the second management unit for requesting the second management unit to return an operating mode informing message indicative of the current operating mode thereof; if the returned operating mode informing message indicates active mode, capable of issuing a standby mode enable message; and whereas if no message is returned, capable of issuing a random timer enable message; (C) a random timer module, which is capable of responding to the random timer enable message from the neighboring unit operating mode inspection module by generating a random time length and then starting countdown until the elapse of the time length, during which the neighboring unit operating mode inspection module keeps inspecting whether an operating mode informing message indicative of active mode is returned from the second management unit; and at the termination of the randomly-generated time length, capable of issuing an active mode enable message; and (D) a local unit operating mode setting module, which is capable of responding to each standby mode enable message by setting the first management unit to standby mode, and responding to each active mode enable message by setting the first management unit to active mode.

The computer platform management unit operating mode arbitration method and system according to the invention is characterized by the utilization of a network interface for message exchanges between the management units, and the utilization of a random timer to set a waiting time length for local management unit to wait for a response from neighboring management unit that tells whether its current operating mode is active mode or standby mode. If no response is received, the local management unit is set to active mode; otherwise, it is set to an operating mode other than the current operating mode of the neighboring management unit. This feature allows the mechanism of operating mode arbitration on the blade server to be more simplified such that the implementation thereof is more cost-effective.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the computer platform management unit operating mode arbitration system of the invention with a blade server;

FIG. 2 is a schematic diagram showing the architecture of the computer platform management unit operating mode arbitration system of the invention; and

FIG. 3 is a schematic diagram showing a sequence of activities performed by the computer platform management unit operating mode arbitration system of the invention.

### DETAILED DESCRIPTION OF PREFERRED EMBODIMENTS

The computer platform management unit operating mode arbitration method and system according to the invention is disclosed in full details by way of preferred embodiments in the following with reference to the accompanying drawings.

### UTILIZATION PURPOSE OF THE INVENTION

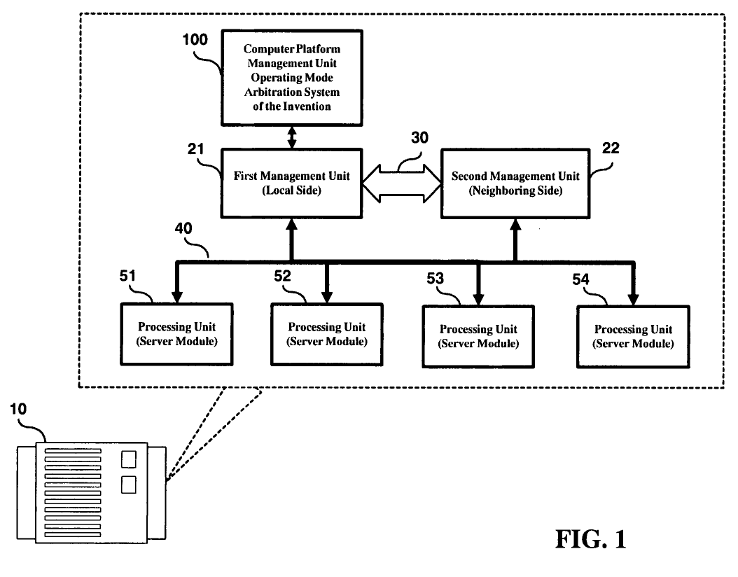

FIG. 1 is a schematic diagram showing the application of the computer platform management unit operating mode arbitration system according to the invention (which is here encapsulated in a box indicated by the reference numeral 100). As shown, the computer platform management unit operating mode arbitration system of the invention 100 is designed for use in conjunction with a computer platform, particularly a clustering type of computer platform of the type having multiple management units, such as a blade server 10 having two management units 21, 22, where the first management unit 21 and the second management unit 22 are linked to each other via a network interface 30, such as an NIC (Network Interface Card) compliant network interface, and linked via a bus interface 40, such as an SMB (System Management Bus) to a group of independent processing units, such as a cluster of server modules 51, 52, 53, 54 in the blade server 10.

During initialization of the blade server 10, one of the first management unit 21 and 20 the second management unit 22 will be set to active mode with the other being set to standby mode; i.e., if the first management unit 21 is set to active mode, then the second management unit 22 is set to standby mode; and on the contrary, if the second management unit 22 is set to active mode, then the first management unit 21 is set to standby mode. During actual operation, the management unit (21 or 22) that is set to active mode is responsible for controlling the operations of the server modules 51, 52, 53, 54; and in the event of a failure to the active mode management unit (21 or 22), the standby mode management unit (22 or 21) will take over the failed one for controlling the operations of the server modules 51, 52, 53, 54. It is the utilization purpose of the computer platform management unit operating mode arbitration system of the invention 100 that when the blade server 10 is turned on and undergoes an initialization procedure, the computer platform management unit operating mode arbitration system of the invention 100 will be activated for arbitration between the first management unit 21 and the second management unit 22 to determine the operating mode thereof.

In practical implementation, the computer platform management unit operating mode arbitration system of the invention 100 can be either integrated to both of the first management unit 21 and the second management unit 22, or just one of them. In the embodiment of FIG. 1, for example, the computer platform management unit operating mode arbitration system of the invention 100 is only integrated to the first management unit 21; and in this case, the first management unit 21 is referred to as “local unit”, whereas the second management unit 22 is referred to as “neighboring unit”. On the contrary, if the computer platform management unit operating mode arbitration system of the invention 100 is integrated to the second management unit 22, then the second management unit 22 is referred to as “local unit”, whereas the first management unit 21 is referred to as “neighboring unit”.

### ARCHITECTURE OF THE INVENTION

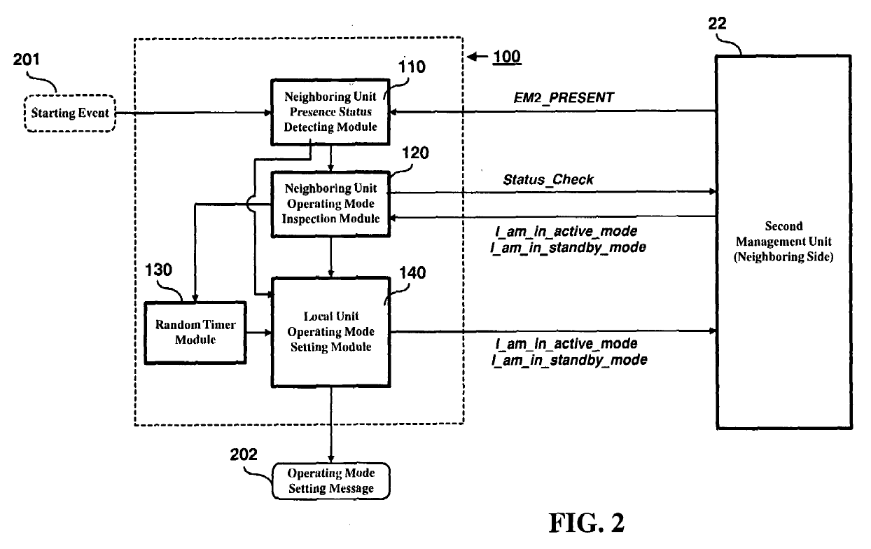

As shown in FIG. 2, in architecture, the computer platform management unit operating mode arbitration system of the invention 100 comprises: (A) a neighboring unit presence status detecting module 110; (B) a neighboring unit operating mode inspection module 120; (C) a random timer module 130; and (D) a local unit operating mode setting module 140. Firstly, the respective attributes and behaviors of these constituent components 110, 120, 130, 140 are described in details in the following

The neighboring unit presence status detecting module 110 is capable of responding to a starting event 201 on the blade server system 10 (i.e., when the blade server system 10 undergoes an initialization procedure) by commanding the first management unit 21 to detect the current presence status of the second management unit 22 via the NIC network interface 30. If the presence status of the second management unit 22 is currently FALSE, the neighboring unit presence status detecting module 110 will set the first management unit 21 to active mode; whereas if TRUE, the neighboring unit presence status detecting module 110 will issue a neighboring unit operating mode inspection enable message to the neighboring unit operating mode inspection module 120. In practical implementation, for example, when the presence status of the second management unit 22 is TRUE, it will issue a logic signal EM2_PRESENT=1; otherwise, if FALSE, it will issue a logic signal EM2_PRESENT=0. In the case of EM2_PRESENT=0, the neighboring unit presence status detecting module 110 will issue an active mode enable message to the local unit operating mode setting module 140; and whereas in the case of EM2_PRESENT=1, the neighboring unit presence status detecting module 110 will issue a neighboring unit operating mode inspection enable message to the neighboring unit operating mode inspection module 120.

The neighboring unit operating mode inspection module 120 is capable of responding to the neighboring unit operating mode inspection enable message from the neighboring unit presence status detecting module 110 by issuing an operating mode inspection request message Status_Check via the network interface 30 to the second management unit 22 for requesting the second management unit 22 to return an operating mode informing message indicative of its current operating mode, i.e., whether the second management unit 22 is currently in active mode or in standby mode. If the second management unit 22 is currently in active mode, it will return an active mode informing message “I_am_in_active_mode” ; otherwise, if in standby mode, it will return a standby mode informing message “I_am_in_standby_mode”. If the returned operating mode informing message is “I_am_in_active_mode”, the neighboring unit operating mode inspection module 120 will responsively issue a standby mode enable message to the local unit operating mode setting module 140. On the contrary, if the active mode informing message “I_am_in_active_mode” is unreceived, it will issue a random timer enable message to the random timer module 130.

The random timer module 130 is capable of responding to the random timer enable message from the neighboring unit operating mode inspection module 120 by generating a random time length and then starting countdown until the elapse of the time length. During the countdown, the neighboring unit operating mode inspection module 120 keeps inspecting whether an active mode informing message “I_am_in_active_mode” is returned from the second management unit 22; if YES, it will issue a standby mode enable message to the local unit operating mode setting module 140. On the contrary, if no active mode informing message “I_am_in_active_mode” is received from the second management unit 22 at the termination of the randomly-generated time length, it will issue an active mode enable message to the local unit operating mode setting module 140.

The local unit operating mode setting module 140 is capable of responding to the occurrence of each standby mode enable message or active mode enable message (either from the neighboring unit presence status detecting module 110, or the neighboring unit operating mode inspection module 120, or the random timer module 130) by issuing a corresponding operating mode setting message 202 to the first management unit 21, by which the first management unit 21 is set to standby mode or active mode. More specifically, if an active mode enable message is received, it will set the first management unit 21 to active mode; and whereas if a standby mode enable message is received, it will set the first management unit 21 to standby mode.

### OPERATION OF THE INVENTION

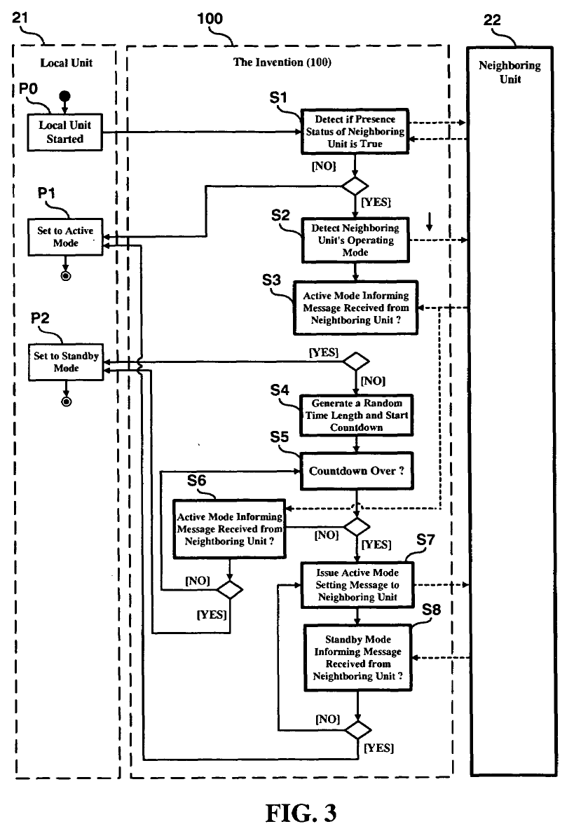

The following is a detailed description of a practical application example of the computer platform management unit operating mode arbitration system of the invention 100 during actual operation, which is described with reference to FIG. 3.

In this application example, it is assumed that the computer platform management unit operating mode arbitration system of the invention 100 is installed to the first management unit 21 for arbitration of active mode and standby mode between the first management unit 21 and the second management unit 22. FIG. 3 is a UML (Unified Modeling Language) compliant activity diagram used to show the activities within the computer platform management unit operating mode arbitration system of the invention 100.

Referring to FIG. 1 through FIG. 3, in actual application, whenever the blade server system 10 is powered on and undergoes an initialization procedure (i.e., a starting event 201 occurs on the blade server system 10), it activates the neighboring unit presence status detecting module 110 to perform the activity Si shown in FIG. 3, wherein the first management unit 21 is activated to detect the current presence status of the second management unit 22 via the NIC network interface 30. If the presence status of the second management unit 22 is FALSE (i.e., EM2_PRESENT=0), then the neighboring unit presence status detecting module 110 will issue a corresponding operating mode setting message 202 to the first management unit 21, causing the first management unit 21 to be set to active mode (the activity P1 shown in FIG. 3). This ends the arbitration procedure.

On the other hand, if the presence status of the second management unit 22 is TRUE (i.e., EM2_PRESENT=1), then the neighboring unit presence status detecting module 110 activates the neighboring unit operating mode inspection module 120 to perform the activities S2 and S3 shown in FIG. 3, wherein the neighboring unit operating mode inspection module 120 issues an operating mode inspection request message Status_Check via the network interface 30 to the second management unit 22 for requesting the second management unit 22 to return an operating mode informing message indicative of its current operating mode (i.e., active mode or standby mode). If the second management unit 22 is currently in active mode, it will return an active mode informing message “I_am_in_active_mode”; otherwise, if in standby mode, it will return a standby mode informing message “I_am_in_standby_mode”. If the returned operating mode informing message is “I_am_in_active_mode”, the neighboring unit operating mode inspection module 120 will responsively activate the local unit operating mode setting module 140 to issue a corresponding operating mode setting message 202 to the first management unit 21, causing the first management unit 21 to be set to standby mode (the activity P2 shown in FIG. 3). This ends the arbitration procedure.

On the other hand, if the neighboring unit operating mode inspection module 120 receives no active mode informing message “I_am_in_active_mode” from the second management unit 22, it will issue a random timer enable message to the random timer module 130, causing the random timer module 130 to perform the activity S4 shown in FIG. 3, wherein the random timer module 130 generates a random time length (as the activity S4 shown in FIG. 3) and then starts a countdown procedure until the elapse of this random-generated time length. During the period of countdown (as the activity S5 shown in FIG. 3), the neighboring unit operating mode inspection module 120 keeps inspecting whether an active mode informing message “I_am_in_active_mode” is returned from the second management unit 22 (as the activity S6 shown in FIG. 3). If YES, the random timer module 130 activates the local unit operating mode setting module 140 to issue a corresponding operating mode setting message 202 to the first management unit 21, causing the first management unit 21 to be set to standby mode (as the activity P2 shown in FIG. 3). This ends the arbitration procedure.

On the contrary, at the termination of the randomly-timed countdown, if no active mode informing message “I_am_in_active_mode” has been received from the second management unit 22, the random timer module 130 will activate the local unit operating mode setting module 140 to perform the activities S7 and S8 shown in FIG. 3. In the activity S7, an active mode informing message “I_am_in_active_mode” is issued to the second management unit 22; and subsequently in the activity S8, it checks whether the second management unit 22 returns a standby mode informing message “I_am_in_standby_mode”. If not, the activity S8 continues; otherwise, if the second management unit 22 returns the “I_am_in_standby_mode” message, the local unit operating mode setting module 140 is activated to issue a corresponding operating mode setting message 202 to the first management unit 21, causing the first management unit 21 to be set to active mode (as the activity P1 shown in FIG. 3). This ends the arbitration procedure.

In conclusion, the invention provides a computer platform management unit operating mode arbitration method and system which is designed for providing a blade server system with an operating mode arbitration function, and which is characterized by the utilization of a network interface for message exchanges between the management units, and the utilization of a random timer to set a waiting time length for local management unit to wait for a response from neighboring management unit that tells whether its current operating mode is active mode or standby mode. If no response is received, the local management unit is set to active mode; otherwise, it is set to an operating mode other than the current operating mode of the neighboring management unit. This feature allows the mechanism of operating mode arbitration on the blade server to be more simplified such that the implementation thereof is more cost-effective. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer platform management unit operating mode arbitration method for use on a computer platform of the type having a first management unit, a second management unit, where the first management unit and the second management unit are linked to each other via a network interface and linked via a bus interface to a group of processing units, for the purpose of providing a operating mode arbitration function to the first management unit and the second management unit;
the computer platform management unit operating mode arbitration method comprising:
in the event of the computer platform being started, commanding the first management unit to detect the current presence status of the second management unit via the network interface; if the presence status is false, setting the first management unit to an active mode;
whereas if the presence status of the second management unit is true, issuing a neighboring unit operating mode inspection requesting message via the network interface to the second management unit for requesting the second management unit to return an operating mode informing message;
if the returned operating mode informing message indicates active mode, issuing a standby mode enable message;
if no message is returned from the second management unit, generating a random time length and then starting countdown until the elapse of the time length, during which the neighboring unit operating mode inspection module keeps inspecting whether an operating mode informing message indicative of active mode is returned from the second management unit; and at the termination of the randomly-generated time length, issuing an active mode enable message; and
responding to each standby mode enable message by setting the first management unit to standby mode, and responding to each active mode enable message by setting the first management unit to active mode.

2. A computer platform management unit operating mode arbitration system for use with a computer platform of the type having a first management unit, a second management unit, where the first management unit and the second management unit are linked to each other via a network interface and linked via a bus interface to a group of processing units, for the purpose of providing a operating mode arbitration function to the first management unit and the second management unit;
the computer platform management unit operating mode arbitration system comprising:
a neighboring unit presence status detecting module, which is capable of responding to a starting event on the computer platform by commanding the first management unit to detect the current presence status of the second management unit via the network interface; if the presence status is false, capable of setting the first management unit to an active mode; whereas if the presence status is true, capable of issuing a neighboring unit operating mode inspection enable message;
a neighboring unit operating mode inspection module, which is capable of responding to the neighboring unit operating mode inspection enable message from the neighboring unit presence status detecting module by issuing an operating mode inspection request message via the network interface to the second management unit for requesting the second management unit to return an operating mode informing message indicative of the current operating mode thereof; if the returned operating mode informing message indicates active mode, capable of issuing a standby mode enable message; and whereas if no message is returned, capable of issuing a random timer enable message;
a random timer module, which is capable of responding to the random timer enable message from the neighboring unit operating mode inspection module by generating a random time length and then starting countdown until the elapse of the time length, during which the neighboring unit operating mode inspection module keeps inspecting whether an operating mode informing message indicative of active mode is returned from the second management unit; and at the termination of the randomly-generated time length, capable of issuing an active mode enable message; and
a local unit operating mode setting module, which is capable of responding to each standby mode enable message by setting the first management unit to standby mode, and responding to each active mode enable message by setting the first management unit to active mode.

3. The computer platform management unit operating mode arbitration system as recited in claim 2, wherein the computer platform is a blade server.

4. The computer platform management unit operating mode arbitration system as recited in claim 2, wherein the network interface is an NIC (Network Interface Card) compliant network interface.

5. The computer platform management unit operating mode arbitration system as recited in claim 2, wherein the bus interface is an SMB (System Management Bus) compliant bus interface.
